(19) United States
(12) Patent Application Publication
(10) Pub. No.: US 2025/0214018 A1
(43) Pub. Date: Jul. 3, 2025

(54) GAS FILTER SYSTEM

(71) Applicant: MANN+HUMMEL GmbH, Ludwigsburg (DE)

(72) Inventors: Pascal NEEF, Trossingen (DE); Christoph WITTMERS, Bietigheim-Bissingen (DE); Andreas WEBER, Freiberg (DE); Dennis STARK, Mauer (DE); Mario RIEGER, Ludwigsburg (DE); Markus HANSELMANN, Lauffen (DE); Peter PEKNY, Neuenmarkt (DE); Eva HALLBAUER, Himmelkron (DE); Daniel SCHMID, Sachsenheim (DE); Steffen GERLACH, Nufringen (DE); Friedrich KUPFER, Marklkofen (DE); Philipp HETTKAMP, Steinheim (DE); Johannes GRAD, Simbach (DE); Pedro Miguel PEREIRA MADEIRA, Bietigheim-Bissingen (DE); Dieter WEISS, Gefrees (DE)

(21) Appl. No.: 19/082,338

(22) Filed: Mar. 18, 2025

Related U.S. Application Data
(63) Continuation of application No. PCT/EP2023/066667, filed on Jun. 20, 2023.

(30) Foreign Application Priority Data
Sep. 20, 2022 (EP) 22196486.9

(51) Int. Cl. B01D 46/24; B01D 46/64

(52) U.S. Cl. CPC B01D 46/2414; B01D 46/64; B01D 2271/027

(57) ABSTRACT

A gas filter system including an outer filter element having a first filter medium arranged between a first end cap and a second end cap, and an inner filter element having a second filter medium arranged between a third end cap and a fourth end cap, wherein the first, second and third end caps are open, the inner filter element is closed at the fourth end cap, the first filter medium is arrangeable to surround the second filter medium, such that the first end cap of the outer filter element surrounds the third end cap of the inner filter element, the first and third end caps are sealed against each other, and such that the second end cap of the outer filter element surrounds the fourth end cap of the inner filter element, and the second and fourth end caps are sealed against each other.

### CROSS-REFERENCE TO RELATED APPLICATIONS

This application is a continuation application of international application No. PCT/EP2023/066667 having an international filing date of Jun. 20, 2023, and designating the United States, the international application claiming a priority date of Sep. 20, 2022, based on prior filed European patent application No. 22 196 486.9, the entire contents of the aforesaid international application and the aforesaid European patent application being incorporated herein by reference.

### TECHNICAL FIELD

The present invention refers to a gas filter system including an outer filter element having a first filter medium arranged between a first end cap and a second end cap, and an inner filter element having a second filter medium arranged between a third end cap and a fourth end cap, wherein the first, second and third end caps are open, the inner filter element is closed at the fourth end cap, and the first filter medium is arrangeable to surround the second filter medium.

### BACKGROUND

Such a filter system is known from DE 10 2018 215 603 A1.

In some applications, it is required to filter a gas flow with two filter elements. Typically, the gas flows through a first filter element and then, the prefiltered gas flows through a second filter element. The filter elements may be arranged in a common housing. This kind of filter systems is for instance used to filter combustion air for large combustion engines, such as for trucks, construction vehicles or the like. Another application is the filtration of air for fuel cells.

DE 10 2018 215 603 A1 discloses a gas filter system with a first filter element which surrounds a second filter element. At a first axial end, open end caps of the two filter elements are associated with an outlet for clean air. At a second axial end, the first (outer) filter element has an open end cap and the second (inner) filter element has a closed end cap. The closed end cap of the second (inner) filter element is arranged to close the opening in the end cap of the first (outer) filter element at the second axial end.

It is an object of the invention to provide a gas filter system with improved sealing between two filter elements, which are adapted for joint use.

This object is achieved by a gas filter system according to the invention and use of filter elements according to the invention. Advantageous embodiments are given in the following description.

### SUMMARY

In accordance with the invention, a gas filter system is provided. The gas filter system includes an outer filter element having a first filter medium arranged between a first end cap and a second end cap, and an inner filter element having a second filter medium arranged between a third end cap and a fourth end cap.

The first, second and third end caps are open. The first, second and third end caps generally have a central opening.

The inner filter element is closed at the fourth end cap. The fourth end cap may be a monolithic closed end cap. Alternatively, a closing means may be permanently affixed to the inner filter element for sealing of the fourth end cap.

The first filter medium is arrangeable to surround the second filter medium. The filter media may be hollow-cylindrical or conical, for example with an essentially circular or oval cross section. The filter media each surround a longitudinal axis. For example, the filter media may be arranged concentric to a common longitudinal axis. Indications of directions such as radial or axial refer to the longitudinal axis of the filter system. In principle, the first and third end caps are associated with a first axial end, and the second and fourth end caps are associated with a second axial end. The end caps cover the filter media in axial direction and in a sectional view will typically have the same geometrical shape as the filter media, e.g. circular or ring-shaped.

During use of the gas filter system, a gas flow is typically first directed through the first filter medium of the outer filter element and then through the second filter medium of the inner filter element.

According to the invention, when the outer filter element is arranged around the inner filter element for use of the gas filter system, the first end cap of the outer filter element surrounds the third end cap of the second filter element, and the second end cap of the outer filter element surrounds the fourth end cap of the inner filter element. In other words, the first and third end caps are arranged at the same axial height along the longitudinal axis. Likewise, the second and fourth end caps are arranged at the same axial height along the longitudinal axis. In this mounted state, the first and third end caps are sealed against each other, for example in the radial direction, and the second and fourth end caps are sealed against each other, for example in the radial direction. By sealing of the first and third end caps against each other, an intermediate space between the first and second filter media is sealed at the first end. By sealing of the second and fourth end caps against each other, an intermediate space between the first and second filter media is sealed at the second end. Therefore, gas to be filtered must flow through the two filter media consecutively. The end caps being arranged at the same axial height must not necessarily mean that the filter bellows have the same height. For example, in case of a shorter inner filter element the third end cap may comprise an axial extension or collar for abutment against the first end cap of the outer filter element.

The first end cap of the outer filter element may have a first sealing section for sealing abutment against a housing, for example in the radial direction. Alternatively or additionally, the first sealing section may provide axial sealing abutment against the housing. The first sealing section may be an integral part of the first end cap.

In general, sealing sections described within the context of this invention are softer than the counterpart against which they seal. For example, a respective sealing section may be made from polyurethane, for example polyurethane foam. The respective counterpart may be made from rigid plastic.

The first end cap of the outer filter element may have a second sealing section for sealing abutment against the third end cap of the inner filter element, for example in the radial direction. The second sealing section may be an integral part of the first end cap. The first end cap—with the first and/or second sealing section—is a monolithic foam part. If the first end cap has the (soft) second sealing section, the third end cap is generally made from a harder material such as rigid plastic and may be glued to the second filter medium.

Alternatively, the third end cap of the inner filter element may have a second sealing section for sealing abutment against the first end cap of the outer filter element, for example in the radial direction. The second sealing section may be an integral part of the third end cap. In this case, the second end cap may be a, for example monolithic, foam part. Then, the first end cap is generally made from a harder material such as rigid plastic and may be glued to the first filter medium.

The second end cap of the outer filter element may have a third sealing section for sealing abutment against the fourth end cap of the inner filter element, for example in the radial direction. The third end cap—with the third sealing section—is a monolithic foam part. If the second end cap has the (soft) third sealing section, the fourth end cap is generally made from a harder material such as rigid plastic and may be glued to the second filter medium.

Alternatively, the fourth end cap of the inner filter element may have a third sealing section for sealing abutment against the second end cap of the outer filter element, for example in the radial direction. The third sealing section may be an integral part of the fourth end cap. In this case, the fourth end cap may be a, for example monolithic, foam part. Then, the second end cap is generally made from a harder material such as rigid plastic and may be glued to the first filter medium.

End caps, which have at least one sealing section, may be made from polyurethane, for example polyurethane foam. End caps, against which a sealing section abuts, may be made from rigid plastic. The plastic end caps may be glued to the respective filter medium.

The second end cap may have at least one support leg for axial support of the outer filter element against a housing. The support leg may be integrally formed with the second end cap.

The gas filter system further comprises a housing, in which the inner and outer filter elements are arrangeable. In a mounted state, the filter elements are arranged inside the housing. Typically, the housing comprises a first housing part associated with the first end and a second housing part associated with the second end. An inlet may be formed at the first or second housing part. An outlet may be formed at the first housing part. The outlet may be in fluid communication with a clean side inside the inner filter element.

The inner filter element has an axial protrusion at the fourth end cap, which protrusion protrudes into an inner hollow space of the inner filter element. The protrusion is integrally formed with the fourth end cap. Alternatively, the protrusion may constitute a closing means for the fourth end cap.

The housing may have a central tube, which extends into the inner filter element at the third end cap in a mounted state of the filter system. The central tube provides guidance to the inner filter element and support to the second filter medium.

The central tube may be held at an axial collar of the housing. This is advantageous for manufacturing the filter housing. A snap fit may be provided between the collar and the central tube.

The protrusion and the central tube overlap each other in the axial direction. Mutual guidance and support between the central tube and the inner filter element may be achieved in this way. This may also facilitate mounting of the filter system. For example, the protrusion may engage into the central tube. In other words, the central tube may surround the protrusion radially outwardly.

The housing has a dome, which protrudes into the protrusion at the fourth end cap. The dome may provide guidance during mounting and additional support to the inner filter element during use of the filter system.

It may further be provided that the dome and the central tube overlap each other in the axial direction. Undesired movement of the filter elements during operation may be effectively reduced with this design. Upon heavy vibration, the central tube may bear against the dome via the protrusion, which is arranged between the central tube and the dome.

If the first filter element and/or the second filter element have/has a rotational symmetric shape it may be advantageous to add a feature which enables installation in a defined position. The protrusion, the central tube and also the dome may have a corresponding protrusion or indentation in the radial direction. In this way the inner filter element and also the cover may be mounted in a defined rotational position. Likewise, the second end cap and the fourth end cap may have a protrusion or indentation in order to define the relative position of the inner filter element and the outer filter element in circumferential direction. Additionally or alternatively, the second end cap and an inner wall of the housing may have a corresponding protrusion and indentation.

The first or the second filter medium, for example the second filter medium of the inner filter element, may have gas-adsorbing properties and may contain activated carbon. Typical harmful gases are SO₂, NOₓ and NH₃.

The first or the second filter medium, for example the first filter medium of the outer filter element, may be made with cellulose.

The first and/or the second filter medium may be pleated.

The invention also relates to the use of an outer filter element and/or an inner filter element in a gas filter system according to the invention, as described above. The gas filter system may be used for cathode air filtration of a fuel cell in an electric vehicle.

### BRIEF DESCRIPTION OF DRAWINGS

Other advantages and features of the invention will be appreciated from the following description of exemplary embodiments of the invention with reference to the figures of the accompanying drawings, which show significant details. The individual features, as described above or explained below, may each be implemented individually or implemented together in any useful combination in variants of the invention.

FIG. 1 shows a gas filter system according to the invention, the gas filter system comprising an outer filter element, an inner filter element and a housing, in a schematic sectional view.

FIG. 2 shows the outer filter element of the gas filter system of FIG. 1, in a schematic sectional view.

FIG. 3 shows the inner filter element of the gas filter system of FIG. 1, in a schematic sectional view.

FIG. 4 shows a first end of the filter system of FIG. 1 in an enlarged view.

FIG. 5 shows a second end of the filter system of FIG. 1 in an enlarged view.

### DETAILED DESCRIPTION

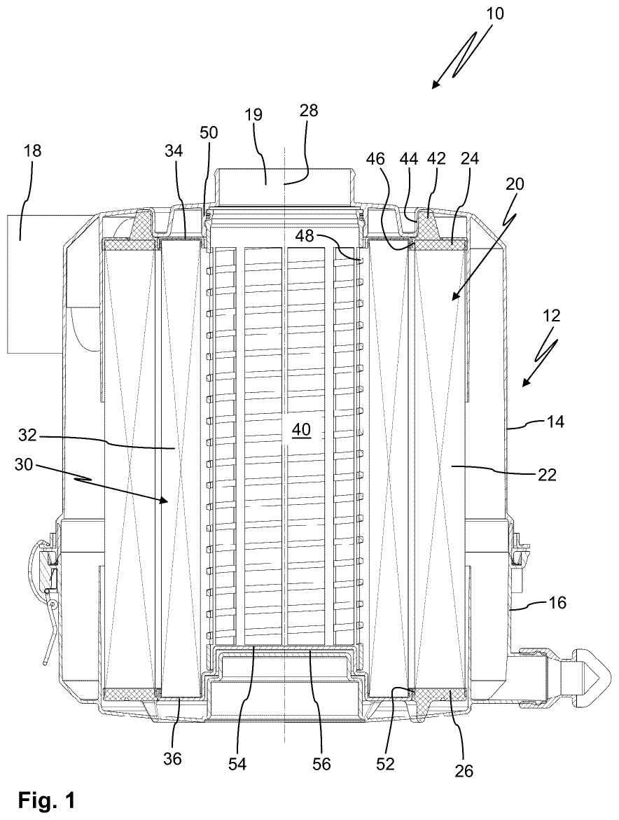

FIG. 1 shows a gas filter system 10. The filter system 10 comprises a housing 12. The housing 12 has a first housing part 14 and a second housing part 16, which are attachable to each other. An inlet 18 allows gas to enter the housing 12. Here, the inlet is formed at the first housing part 14. An outlet 19 for filtered gas is also formed at the first housing part 14. The housing parts 14, 16 may be made from metal and/or rigid plastic.

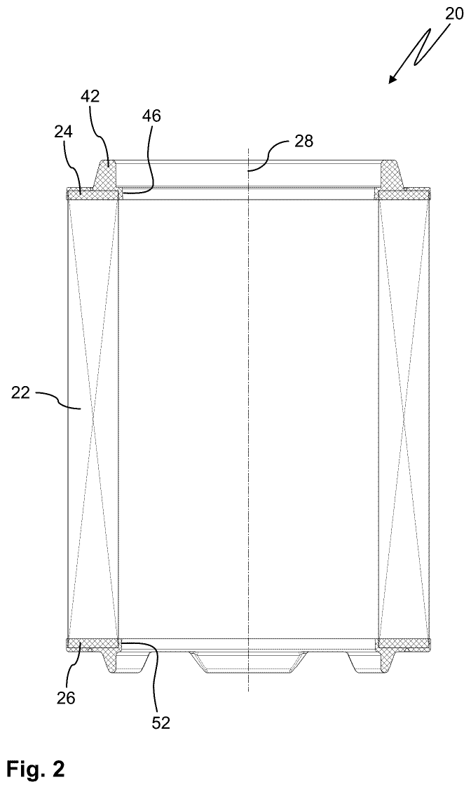

The filter system 10 further comprises an outer filter element 20, see also FIG. 2. The outer filter element 20 comprises a first filter medium 22. The first medium 22 is contained between a first end cap 24 and a second end cap 26. The first filter medium 22 surrounds a longitudinal axis 28 in a circular manner. The first filter medium 22 may be made from pleated cellulose paper.

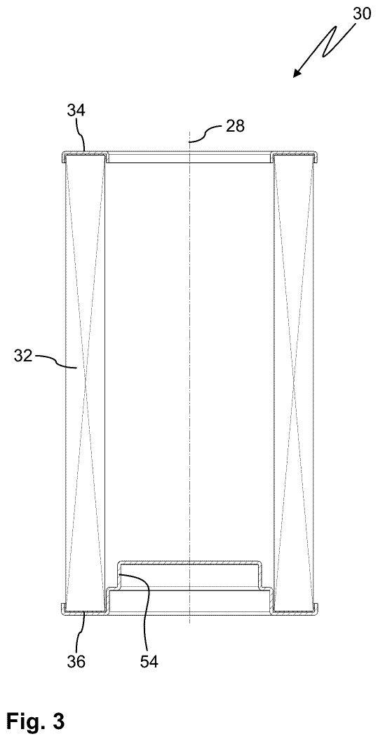

The filter system 10 further comprises an inner filter element 30, see also FIG. 3. The inner filter element 30 comprises a second filter medium 32. The second medium 32 is contained between a third end cap 34 and a fourth end cap 36. The second filter medium 32 also surrounds the longitudinal axis 28 in a circular manner. The second filter medium 32 may be pleated and may contain activated carbon in order to achieve gas-adsorbing properties.

The inner filter element 30 is arranged inside the outer filter element 20. Both filter elements 20, 30 are arranged inside the housing 12. Here, the first and second filter media 22, 32 are concentric to one another and to the longitudinal axis 28.

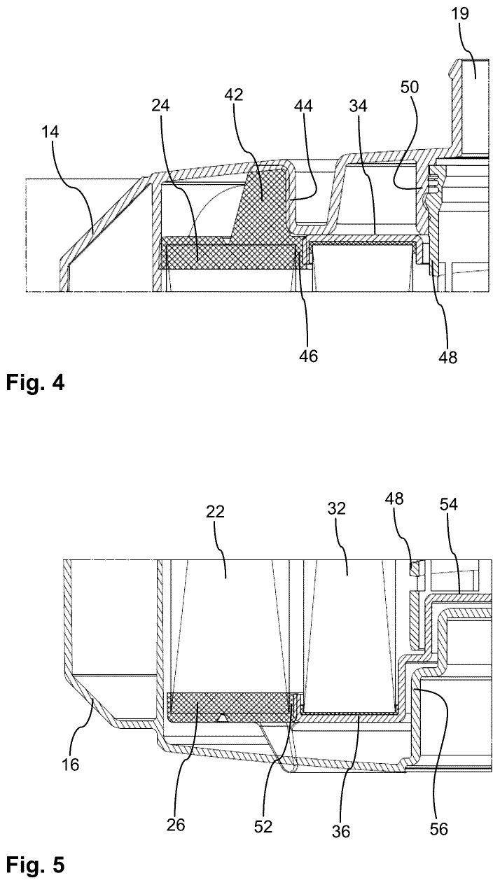

At a first end of the filter system 10, the first end cap 24 is arranged to surround the third end cap 34, see also FIG. 4. The first end cap 24 and the third end cap 34 each have a central opening, see also FIG. 2 and FIG. 3, respectively. The outlet 19 is in fluid communication with a clean side 40 within the inner filter element 30, cf. FIG. 1.

The first end cap 24 of the outer filter element 20 is axially and/or radially sealed against the housing 12. A first sealing section 42 axially protrudes from the first end cap 24. The first sealing section 42 abuts the first housing part 14 in the axial and in the radial direction. The first housing part 14 has a circumferential rib 44, against which the first sealing section 42 of the first end cap 24 rests in the radial direction.

The first end cap 24 and the third end cap 34 are sealed against each other. In the depicted embodiment, a radial sealing is established. The first end cap 24 has a second sealing section 46. The second sealing section 46 sealingly abuts the third end cap 34 in the radial direction.

In the depicted embodiment, the first end cap 24 with the first sealing section 42 and the second sealing section 46 is integrally made from polyurethane foam. In other words, the first end cap 24 with its sealing sections 42, 46 is a monolitic part. The third end cap 34 is made from rigid plastic and glued to the second filter medium 32.

A central tube 48 of the housing 12 is held at an axial collar 50, cf. FIG. 1 and FIG. 4. The collar 50 axially protrudes into the housing 12 at the outlet 19. The central tube 48 extends through the opening of the third end cap 34 towards the fourth end cap 36. The central tube 48 may be made from rigid plastic.

At a second end of the filter system 10, the second end cap 26 is arranged to surround the fourth end cap 36, see also FIG. 5. The second end cap 26 has a central opening, see also FIG. 2. The fourth end cap 36 is closed, see also FIG. 3. In the depicted embodiment, the fourth end cap 36 is a monolitic closed end cap. The fourth end cap 36 may be made from rigid plastic and may be glued to the second filter medium 32.

The second end cap 26 and the fourth end cap 36 are sealed against each other. In the depicted embodiment, a radial sealing is established. The second end cap 26 has a third sealing section 52. The third sealing section 52 sealingly abuts the fourth end cap 36 in the radial direction. The second end cap 26 with the third sealing section 52 may be integrally formed from polyurethane foam. In other words, the second end cap 26 with its sealing section 52 is a monolitic part.

In its central area (radially within the second filter medium 32), the fourth end cap 36 forms a protrusion 54, see FIG. 1, FIG. 3 and FIG. 5. The protrusion 54 extendes into the inner filter element 30 in the axial direction towards the third end cap 34.

The central tube 48 of the housing 12 and the protrusion 54 of the inner filter element 30 overlap each other along the longitudinal axis 28. The protrusion 54 may be tapered in order to extend into the central tube 48.

The housing 12 may have a dome 56. Here, the dome 56 is formed at the second housing part 16, which may be a removable cover. The dome 56 extends towards the inside of the inner filter element 30. For example, the dome 56 extends into the protrusion 54 of the inner filter element 30. For example, as the protrusion 54 protrudes into the central tube 48, the dome 56, the protrusion 54 and the central tube 48 overlap each other along the longitudinal axis 28.

### REFERENCE NUMBERS

Gas filter system 10
Housing 12
First housing part 14
Second housing part 16
Inlet 18
Outlet 19
Outer filter element 20
First filter medium 22
First end cap 24
Second end cap 26
Longitudinal axis 28
Inner filter element 30
Second filter medium 32
Third end cap 34
Fourth end cap 36
Clean side 40
First sealing section 42
Rib 44
Second sealing section 46
Central tube 48
Collar 50
Third sealing section 52
Protrusion 54
Dome 56

1. A gas filter system comprising:
an outer filter element having a first filter medium arranged between a first end cap and a second end cap; and
an inner filter element having a second filter medium arranged between a third end cap and a fourth end cap;
the first, second and third end caps being open;
the inner filter element being closed at the fourth end cap;
the first filter medium being arrangeable to surround the second filter medium, such that the first end cap of the outer filter element surrounds the third end cap of the inner filter element, the first and third end caps being sealed against each other, and such that the second end cap of the outer filter element surrounds the fourth end cap of the inner filter element, the second and fourth end caps being sealed against each other, wherein the inner filter element has an axial protrusion at the fourth end cap, which protrusion protrudes into an inner hollow space of the inner filter element.

2. The gas filter system according to claim 1, wherein the fourth end cap is a monolithic closed end cap.

3. The gas filter system according to claim 1, wherein the first end cap of the outer filter element has a first sealing section for sealing abutment against a housing in a radial direction.

4. The gas filter system according to claim 2, wherein the first end cap of the outer filter element has a second sealing section for sealing abutment against the third end cap of the inner filter element in the radial direction.

5. The gas filter system according to claim 1, wherein the first end cap is a monolithic foam part.

6. The gas filter system according to claim 4, wherein the second end cap of the outer filter element has a third sealing section for sealing abutment against the fourth end cap of the inner filter element in the radial direction.

7. A gas filter system according to claim 1, further comprising a housing, in which the outer filter element and the inner filter element are arrangeable.

8. The gas filter system according to claim 7, wherein the housing has a central tube that extends into the inner filter element at the third end cap.

9. The gas filter system according to claim 8, wherein the protrusion and the central tube overlap each other in an axial direction.

10. The gas filter system according to claim 8, wherein the housing further has a dome that protrudes into the protrusion at the fourth end cap.

11. The gas filter system according to claim 10, wherein the dome and the central tube overlap each other in an axial direction.

12. The gas filter system according to claim 1, wherein the first filter medium or the second filter medium has gas-adsorbing properties.

13. The gas filter system according to claim 1, wherein the first filter medium or the second filter medium is made from cellulose.

14. Use of the outer filter element and/or the inner filter element in the gas filter system according to claim 1.
